(19) United States
(12) Patent Application Publication
(10) Pub. No.: US 2026/0241533 A1
(43) Pub. Date: Aug. 20, 2026

(54) HAND-HELD POWER TOOL

(71) Applicant: JIANGSU DONGCHENG TOOLS TECHNOLOGY CO., LTD., NANTONG, JIANGSU (CN)

(72) Inventors: AIGUO LIU, NANTONG, JIANGSU (CN); SIHAO YANG, NANTONG, JIANGSU (CN)

(21) Appl. No.: 18/870,380

(22) PCT Filed: Apr. 11, 2024
(86) PCT No.: PCT/CN2024/087311

§ 371 Date: Nov. 27, 2024

(30) Foreign Application Priority Data
May 30, 2023 (CN) 202310627874.9

(51) Int. Cl. B25F 5/00; B25F 5/02

(52) U.S. Cl. CPC B25F 5/001; B25F 5/02

(57) ABSTRACT

A hand-held power tool is provided. The hand-held power tool includes a housing, a motor assembly and a transmission assembly arranged on the housing, a switch assembly connected to the motor assembly and including switch component arranged on the housing and a trigger configured to trigger the switch component, a shift assembly connected to the transmission assembly and including a shift component connected to the transmission assembly and a button configured to move the shift component, and an output end configured to be driven by the transmission assembly. The switch assembly is a speed adjusting switch configured to adjust an output speed of the motor assembly through a pressing stroke of the trigger. The trigger includes a base and a limiting portion arranged on the base, the shift assembly includes a stop portion arranged corresponding to the limiting portion configured to abut against the stop portion.

### CROSS REFERENCE TO RELATED APPLICATIONS

The present application is a 35 U.S.C. 371 National Phase Application of International Patent Application No. PCT/CN2024/087311, filed Apr. 11, 2024, which claims foreign priority to Chinese Patent Application No. 202310627874.9, filed May 30, 2023, both of which are hereby incorporated by reference in their entireties.

### TECHNICAL FIELD

The present application relates to the field of power tools, in particular to a hand-held power tool used in decoration, construction, or the like.

### BACKGROUND

A power tool is a type of device in which a working head is driven by a motor assembly to reciprocate. In order to shift a high-speed and low-torque force of the motor assembly into a low-speed and high-torque force required by a user, a planetary gear reduction device is usually arranged between the motor assembly and the working head. With the increasing demand of the user, a speed change device is arranged on the planetary gear reduction device of a hand-held power tool on the market, especially an electric drill. The user may adjust an output speed of the electric drill according to an actual use requirement. The speed change device of the electric drill in the related art sets a high-speed mode and a low-speed mode, and is configured to manually shift by a mode adjusting mechanism.

However, in the related art, when the planetary gear reduction device is required to obtain a lower output speed, multi-stage planetary gears are required for deceleration, which makes the overall size of the power tool large and is not conducive to the development of miniaturization. In addition, based on the theoretical model of planetary gear, the reduction ratio of each stage is 1+Z3/Z1, where Z3 is the number of teeth of the inner gear ring, Z1 is the number of teeth of the sun gear, and the reduction ratio of each stage of the planetary gear is not less than 3. When the electric drill is required to design to have the speed ratio between the high-speed mode and the low-speed mode of less than 3, the traditional planetary gear reduction device cannot be achieved, so that the traditional planetary gear reduction device cannot meet multiple operation requirements of the user.

### SUMMARY

A hand-held power tool is provided and includes a housing, a motor assembly and a transmission assembly both arranged on the housing, a switch assembly connected to the motor assembly, a shift assembly connected to the transmission assembly, and an output end configured to be driven by the transmission assembly. The switch assembly includes switch component arranged on the housing and a trigger configured to trigger the switch component. The shift assembly includes a shift component connected to the transmission assembly and a button configured to move the shift component. The switch assembly is a speed adjusting switch configured to adjust an output speed of the motor assembly through a pressing stroke of the trigger. The trigger includes a base and a limiting portion arranged on the base, the shift assembly includes a stop portion arranged corresponding to the limiting portion, and the limiting portion is configured to abut against the stop portion.

A hand-held power tool is provided and includes a housing; a motor assembly and a transmission assembly, both arranged on the housing; a switch assembly, connected to the motor assembly, and comprising a switch component arranged on the housing and a trigger configured to trigger the switch component; a shift assembly, connected to the transmission assembly, and comprising a shift component connected to the transmission assembly, a button configured to move the shift component, and a stop portion connected to the button; and an output end, configured to be driven by the transmission assembly; wherein the switch assembly is a speed adjusting switch configured to adjust an output speed of the motor assembly through a pressing stroke of the trigger; states of the output end comprise a first state and a second state, and speeds in the first state and the second state are different; positions of the button comprise a first position corresponding to the first state and a second position corresponding to the second state; the trigger comprises a base, an end surface of the base defines a slideway, the slideway comprises a first slideway corresponding to the first position and a second slideway corresponding to the second position, the stop portion is configured to move with movement of the button and configured to shift between the first state and the second state by moving in the first slideway or in the second slideway.

A hand-held power tool is provided and includes a housing; a motor assembly and a transmission assembly, both arranged on the housing; a switch assembly, connected to the motor assembly, and comprising a switch component arranged on the housing and a trigger configured to trigger the switch component; a shift assembly, connected to the transmission assembly, and comprising a shift component connected to the transmission assembly and a button configured to move the shift component; and an output end, configured to be driven by the transmission assembly. states of the output end comprise a first state and a second state, the first state is a low-speed mode state and the second state is a high-speed mode state; wherein the switch assembly is a speed adjusting switch configured to adjust an output speed of the motor assembly through a pressing stroke of the trigger; the trigger is moveable between a part of the pressing stroke in at least one of the first state and the second state, and the speed ratio of the speed in the high-speed mode state to the speed in the low-speed mode state is less than 3.

### BRIEF DESCRIPTION OF THE DRAWINGS

Embodiments of the present disclosure are described in detail below in combination with drawings.

FIG. 1 is a structural schematic view of a hand-held power tool in a low-speed mode state according to some embodiments of the present disclosure.

FIG. 2 is a structural schematic view of a hand-held power tool in a high-speed mode state according to some embodiments of the present disclosure.

FIG. 3 is a structural schematic view of a shift assembly located in two positions at different time according to some embodiments of the present disclosure.

FIG. 4 is a structural schematic view of another view angle of the shift assembly shown in FIG. 3.

FIG. 5 is a structural schematic view of a first view angle of a shift assembly and a switch assembly in the hand-held power tool shown in FIG. 1.

FIG. 6 is a structural schematic view of a second view angle of the shift assembly and the switch assembly shown in FIG. 5.

FIG. 7 is a structural schematic view of a third view angle of the shift assembly and the switch assembly shown in FIG. 5.

FIG. 8 is a structural schematic view of connection between an intermediate plate and a guide member in a shift assembly according to some embodiments of the present disclosure.

FIG. 9 is a structural schematic view of connection between a button and a guide member in a shift assembly according to some embodiments of the present disclosure.

FIG. 10 is a structural schematic view of a stop portion and a trigger of the hand-held power tool in the low-speed mode state shown in FIG. 1.

FIG. 11 is a structural schematic view of a stop portion and a trigger of the hand-held power tool in the high-speed mode state shown in FIG. 2.

FIG. 12 is a structural schematic view of a trigger in the hand-held power tool shown in FIG. 1.

FIG. 13 is a structural schematic view of another view angle of the trigger shown in FIG. 12.

### DETAILED DESCRIPTIONS

The present disclosure is described in detail below in combination with the drawings and some embodiments.

Terms used in the present disclosure are only for purpose of describing particular embodiments, not for limiting the present disclosure. For example, following terms indicating orientations or position relationships, such as “up”, “down”, “front”, “rear”, “left”, “right”, and so on are only based on orientations or position relationships shown in the drawings, and are only for convenience of describing the present disclosure and simplifying description, rather than indicating or implying that a device or a component referred to must have a particular orientation or be constructed and operated in a particular orientation. Therefore, the terms cannot be understood as a limitation of the present disclosure.

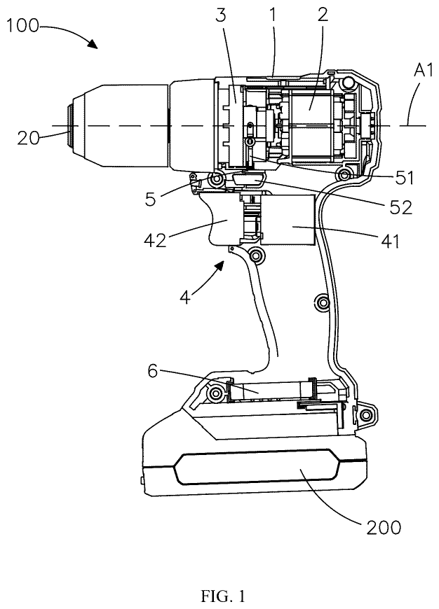

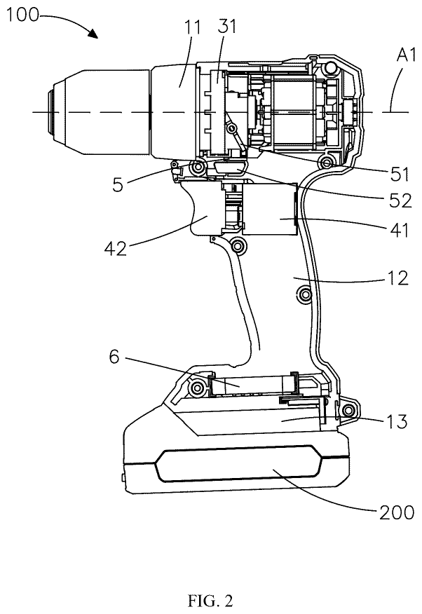

As shown in FIGS. 1 and 2, some embodiments of the present disclosure provide a hand-held power tool, the hand-held power tool may be at least one of an electric drill, an angle grinder, a hammer drill or the like. The electric drill 100 powered by direct current, and the electric drill 100 is configured to screw or unscrew a screw, or drill a hole, etc. The electric drill 100 includes a housing 1, a motor assembly 2 and a transmission assembly 3 both arranged on the housing 1, a switch assembly 4 connected to the motor assembly 2, a shift assembly 5 connected to the transmission assembly 3, an output end 20 driven by the transmission assembly 3, a controlling assembly 6 configured to control the motor assembly 2, and a battery pack 200 configured to supply energy to the motor assembly 2. The battery pack 200 is detachably arranged on the housing 1 to facilitate charging the battery pack 200. In some embodiments, the switch assembly 4 is electrically connected to the controlling assembly 6. When a user presses the switch assembly 4, the motor assembly 2 is started and rotates at a high speed, and a force is transmitted to the output end 20 through the transmission assembly 3, and the output end 20 clamping a screwdriver set head may operate a workpiece.

In some embodiments of the present disclosure, the transmission assembly 3 is a planetary gear reduction mechanism, and is configured to shift a high-speed and low-torque force output by the motor assembly 2 into a low-speed and high-torque force required by the user. In order to meet multiple requirements of the user, states of the output end 20 may include a first state and a second state, and a speed of the output end 20 in the first state is different from a speed of the output end 20 in the second state. Correspondingly, and the planetary gear reduction mechanism includes a movable inner gear ring 31. The first state is a low-speed mode state, and when the output end 20 is in the first state, the inner gear ring 31 play a role in a deceleration process, and the output end 20 operates at a low speed. The second state is a high-speed mode state, and when the output end 20 is in the second state, the inner gear ring 31 is separated and does not play a role in the deceleration process, and the output end 20 operates at a high speed. The speed in the high-speed mode state is higher than the speed in the low-speed mode state.

In some embodiments, the shift assembly 5 is connected to the inner gear ring 31 of the planetary gear reduction mechanism, and the user may drive the inner gear ring 31 to move by moving the shift assembly 5, so as to shift between the first state and the second state.

As shown in FIGS. 1 and 2, the housing 1 includes a body portion 11 accommodating the motor assembly 2 and the transmission assembly 3, a holding portion 12 connected to the body portion 11, and a joint portion 13 arranged on an end of the holding portion 12. The body portion 11 and the joint portion 13 are arranged on an upper side and a lower side of the holding portion 12, that is, the holding portion 12 is arranged at the body portion 11 and the joint portion 13 is arranged on an end of the holding portion 12 away from the body portion 11. In some embodiments, the holding portion 12 and the body portion 11 are arranged at an angle to meet to ergonomics, that is, the angle is greater than 0 degrees and less than 120 degrees, so that the user may comfortably hold. The switch assembly 4 is arranged on the upper end of the holding portion 12 close to the body portion 11, so that the user may hold the holding portion 12 with the entire palm, and may press the switch assembly by a single index finger or a single middle finger, which is comfortable and convenient for operation.

In some embodiments of the present disclosure, the battery pack 200 is detachably arranged on the joint portion 13, the motor assembly 2 has a first axis A1 extending in a front-rear direction, and an insertion direction of the battery pack 200 is substantially the same as the extension direction of the first axis A1, so that the electric drill 100 may be stably placed on a working surface based on support of the battery pack 200.

In some embodiments, the nominal voltage of the battery pack 200 may be greater than or equal to 10V and less than or equal to 20V, such as 12V, 18V, or 20V, etc. In some embodiments, the nominal voltage of the battery pack 200 may be greater than or equal to 20V and less than or equal to 100V, such as 24V, 40V, 56V, or 80V, etc.

In some embodiments, the number of electric core units included in one electric core unit group of the battery pack 200 may be greater than or equal to 3 and less than or equal to 5, such as 3, 4, or 5. In some embodiments, the number of electric core units included in one electric core unit group of the battery pack 200 may be greater than or equal to 6 and less than or equal to 25, such as 6, 10, 14, or 20, etc.

In some embodiments of the present disclosure, the switch assembly 4 includes a switch component 41 arranged in the housing 1 and a trigger 42 configured to trigger the switch component 41. In some embodiments, the switch assembly 4 is a speed adjusting switch and is configured to adjust the output speed of the motor assembly 2 through a pressing stroke of the trigger 42, and the output speed of the motor assembly 2 is substantially proportional to the pressing stroke of the trigger 42. In some embodiments, when the user presses the trigger 42 move through a full pressing stroke (that is, the trigger 42 moves to the farthest position), the motor assembly 2 operates at a maximum output speed. When the user presses the trigger 42 to a half of the full pressing stroke, the motor assembly 2 operates at a speed of a half of the maximum output speed.

It should be understood that the switch assembly 4 is individually well-known and conventional. Specifically, the switch assembly 4 may be a continuously variable switch. Further, the switch assembly 4 may be a direct-current speed switch, and is configured to adjust the speed of the motor assembly 2 in the power tool.

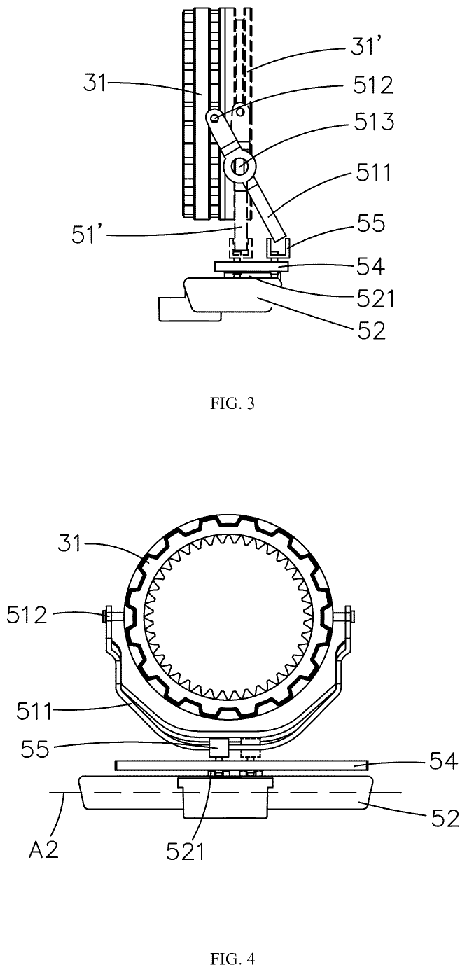

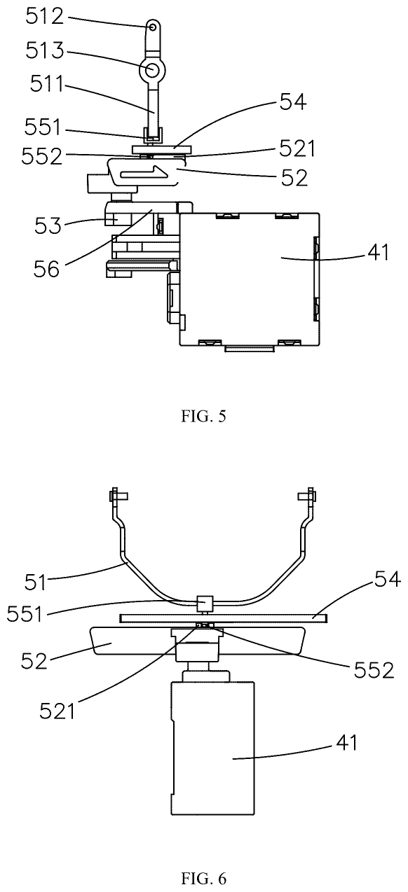

As shown in FIGS. 3 to 7, the shift assembly 5 includes a shift component 51 connected to the inner gear ring 31 of the transmission assembly 3, a button 52 configured to move the shift component 51, a stop portion 53 connected to the button 52, an intermediate plate 54 fixed to the housing 1, and a guide member 55 connected between the shift component 51 and the button 52. Positions of button 52 include a first position corresponding to the first state and a second position corresponding to the second state. That is, the button 52 can move back and forth between the first and second positions. When moved to the first position, the button 52 is in the first state, and when moved to the second position, the button 52 is in the second state. The user may shift between the first state and the second state by moving the button 52.

FIG. 3 is schematics view of different positions of the shift component 51 (51′) and the inner gear ring 31 (31′) in two states.

In some embodiments of the present disclosure, the button 52 is located between the transmission assembly 3 and the switch assembly 4, the button 52 extends in a direction of a second axis A2 substantially perpendicular to the first axis A1, and two ends of the button 52 extend out of the housing 1 for the user to operate. In this way, when grasping the holding portion 12, the user may abut against the two ends of the button 52 with a thumb finger and an index finger, and may push the button 52 to reciprocate along the second axis A2, so that the button 52 may be quickly shifted between the first position and the second position. Since the mode shifting may be completed by a single hand, the operation is simple and the user experience is good. In addition, the button 52 is arranged between the transmission assembly 3 and the switch assembly 4, so that the height occupied by the body portion 11 in the upper and lower directions is reduced, so that the electric drill 100 may be normally used in a narrow space, and may perform good in a edge operation.

In some embodiments of the present disclosure, the controlling assembly 6 is arranged in the holding portion 12 and is located at the lower side of the switch assembly 4, and the button 52 is located at the upper sides of the switch assembly 4, so that the arrangement of components of the electric drill 100 is reasonable.

In some embodiments, the controlling assembly 6 is arranged in the body portion 11, and is located on the rear side of the motor assembly 2.

In some embodiments of the present disclosure, the shift component 51 extends in a circumferential direction of the inner gear ring 31. The shift component 51 includes a U-shaped connecting portion 511, a pair of connecting arms 512 respectively arranged on two ends of the connecting portion 511 in one-to-one correspondence, a pivoting portion 513 arranged between the connecting portion 511 and one connecting arms 512. The pair of connecting arms 512 are respectively connected to two sides of the inner gear ring 31 in one-to-one correspondence, and the pivoting portion 513 is arranged on the housing 1. When the button 52 moves along the second axis A2, the shift component 51 is driven to rotate around the pivoting portion 513, and the inner gear ring 31 is driven to move along the first axis Al, so as to achieve free shifting between two mode states.

As shown in FIG. 8, the intermediate plate 54 is located between the shift component 51 and the button 52, extends in the direction of the second axis A2, and is substantially parallel to the button 52. The intermediate plate 54 defines a guide groove 541 extending through the intermediate plate 54, the guide member 55 is configured to move in the guide groove 541. The intermediate plate 54 is fixed, and the guide groove 541 is configured to guide the movement of the guide member 55.

In some embodiments, the second axis A2 is approximately perpendicular to the first axis A1. In order to shift the movement of the button 52 in the direction of the second axis A2 into the movement of the inner gear ring 31 in the direction of the first axis A1, the extension direction of the guide groove 541 and the second axis A2 are arranged at an angle, and the angle is greater than 0 degrees and less than 180 degrees.

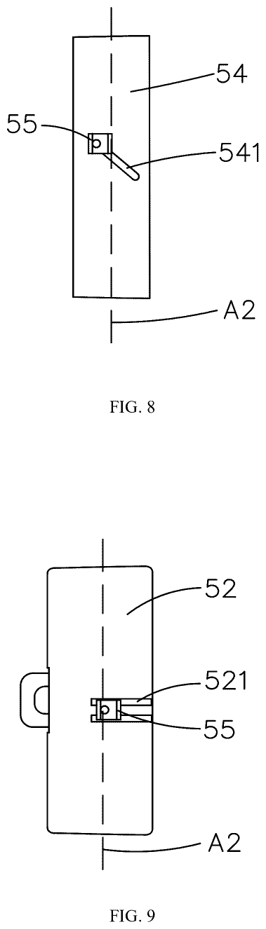

As shown in FIG. 9, the button 52 includes a pair of flanges 521 extending from the end surface of the button 52 toward the intermediate plate 54, the pair of flanges 521 extend parallel to each other and are perpendicular to the second axis A2. The guide member 55 is located between the pair of flanges 521, abuts against the flange 521, and is configured to slide along a sidewall of the pair of flanges 521.

In some embodiments of the present disclosure, the guide member 55 includes a jaw 551 connected to the shift component 51 and a guide pillar 552 extending downwardly from the bottom of the jaw 551, the guide pillar 552 penetrates the guide groove 541 and abuts against the flange 521. In some embodiments, the jaw 551 is in a U-shape, and the connecting portion 511 of the shift component 51 is at least partially located in the jaw 551.

In some embodiments of the present disclosure, the jaw 551 and the guide pillar 552 are integrally formed.

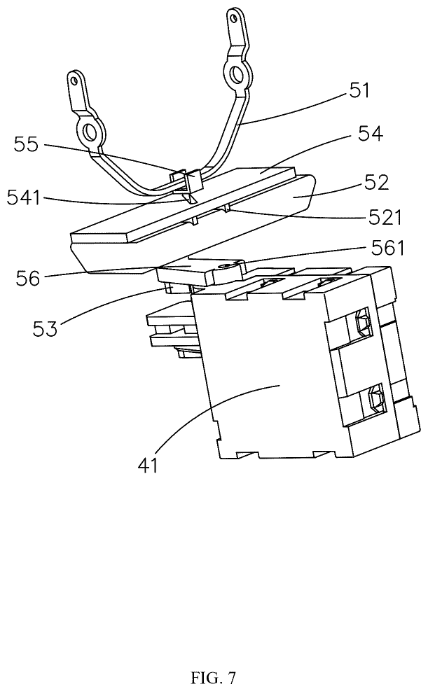

As shown in FIGS. 5 and 7, the stop portion 53 is connected to the lower side of the button 52, and is configured to move with the movement of the button 52, and the stop portion 53 is located between the button 52 and the trigger 42. In some embodiments, the stop portion 53 is connected to a side of the button 52 away from the intermediate plate 54.

In some embodiments, the stop portion 53 extends downward from the lower side of the button 52, and the stop portion 53 and the button 52 are integrally formed.

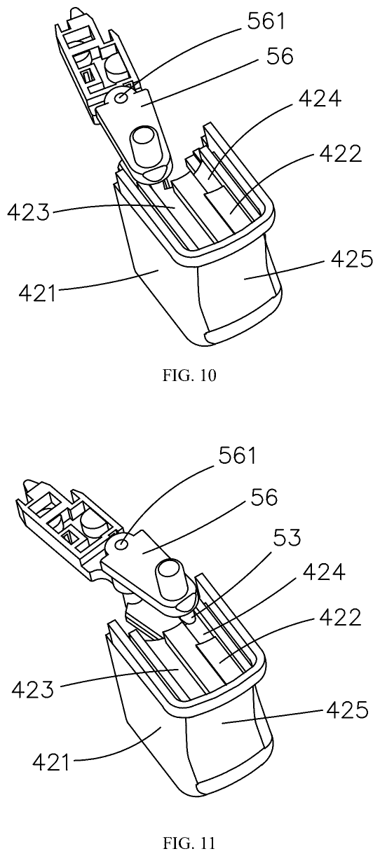

As shown in FIGS. 10 and 11, the shift assembly 5 may include an adjustment plate 56 connected to the button 52, the adjustment plate 56 extends from the stop portion 53 toward the switch component 41. The adjustment plate 56 has a pivoting point 561 connected to the switch component 41. When the user moves the button 52, the adjustment plate 56 is driven to rotate around the pivoting point 561, and the adjustment plate 56 may generate different signals for the switch component 41 during rotation, and the signals may be configured to achieve the forward-reverse rotation shifting of the motor assembly 2.

In some embodiments, an elastic sheet may be arranged on the connection position between the pivoting point 561 of the adjustment plate 56 and the switch component 41, so that the user has a good operating feel when moving the button 52.

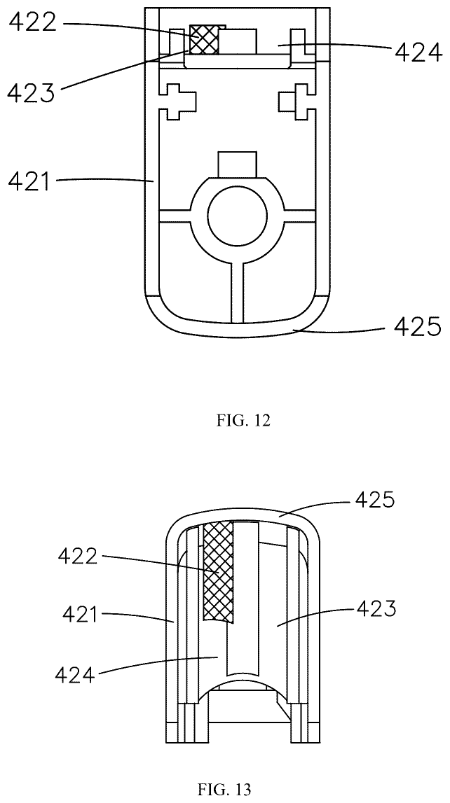

As shown in FIGS. 10 to 13, the trigger 42 includes a base 421, a limiting portion 422 arranged on the base 421, and a pressing portion 425 configured to be pressed by the user. The pressing portion 425 and the limiting portion 422 are respectively located on different end surfaces of the base 421. In some embodiments, the pressing portion 425 is located on the side of the base 421 away from the switch component 41. The limiting portion 422 is arranged on another end face of the base 421, that is, the limiting portion 422 is located on the upper side of the base 421, is arranged close to the stop portion 53. In some embodiments, the limiting portion 422 is arranged on a side of the base 421 facing to the shift assembly 5. The stop portion 53 is located on a path of the pressing stroke of the trigger 42. In this way, during the pressing process of the trigger 42, the limiting portion 422 abuts against the stop portion 53, and the trigger 42 cannot move through the full pressing stroke (that is, the trigger 42 cannot move to the farthest position). Therefore, the maximum output speed of the motor assembly 2 is limited. In actual use, the output end 20 may output the force required by the user at a lower speed meet the needs of different working scenarios of the user.

In some embodiments of the present disclosure, the stop portion 53 is located between the button 52 and the base 421, and the stop portion 53 is at least partially located between the trigger 42 and the switch component 41.

In some embodiments of the present disclosure, the end surface of the base 421 facing the stop portion 53 defines a slideway, that is, the slideway is defined on the upper side of the base 421, and the stop portion 53 is configured to move in the slideway. The limiting portion 422 is arranged on the slideway, so that the trigger 42 cannot move through the full pressing stroke (that is, the trigger 42 cannot move to the farthest position) to limit the maximum output speed of the motor assembly 2.

In some embodiments, the slideway includes a first slideway 423 corresponding to the first position and a second slideway 424 corresponding to the second position, and the limiting portion 422 is arranged on at least one of the first slideway 423 and the second slideway 424. In the first state, the stop portion 53 is configured to move within the first slideway 423. In the second state, the stop portion 53 is configured to move within the second slideway 424.

In some embodiments, the limiting portion 422 is arranged on the second slideway 424. The first state is the low-speed mode state, and corresponds to the first position and the first slideway 423. The second state is the high-speed mode state, and corresponds to the second position and the second slideway 424. Based on the theoretical model of planetary gear, the reduction ratio of each stage is 1+Z3/Z1, where Z3 is the number of teeth of the inner gear ring, Z1 is the number of teeth of the sun gear, and the reduction ratio of each stage of planetary gear is not less than 3. When the electric drill is required to design to have the speed ratio between the high-speed mode and the low-speed mode of less than 3, the traditional planetary gear reduction device cannot be achieved.

However, in some embodiments of the present disclosure, the limiting portion 422 is arranged on the second slideway 424. When the user presses the trigger 42 in the high-speed mode state, and the limiting portion 422 abuts against the stop portion 53, so that the trigger 42 cannot move through the full pressing stroke (that is, the trigger 42 cannot move to the farthest position). Therefore, the maximum output speed of the motor assembly 2 is limited. Even in the high-speed mode state, the user may obtain the force at the lower speed, which breaks through the limit that the traditional planetary gear reduction device cannot achieve the speed ratio of the speed in the high-speed mode state to the speed in the low-speed mode state being less than 3, and effectively meets the multiple working requirements of the user.

In some embodiments, the speed ratio of the speed in the high-speed mode state to the speed in the low-speed mode state is less than 3.

In some embodiments of the present disclosure, the limiting portion 422 is arranged on the second slideway 424, so that the length of the second slideway 424 is less than the length of the first slideway 423. The lengths of the first slideway 423 and the second slideway 424 may be adjusted according to the actual need of the output speed.

The present disclosure is not limited to above embodiments. Those skilled in the art can easily understand that there are many alternatives to the hand-held power tool of the present disclosure without departing from the principle and scope of the present disclosure. The scope of the present disclosure is subject to the claims.

1. A hand-held power tool, comprising
a housing;
a motor assembly and a transmission assembly, both arranged on the housing;
a switch assembly, connected to the motor assembly, and comprising a switch component arranged on the housing and a trigger configured to trigger the switch component;
a shift assembly, connected to the transmission assembly, and comprising a shift component connected to the transmission assembly and a button configured to move the shift component; and
an output end, configured to be driven by the transmission assembly;
wherein the switch assembly is a speed adjusting switch configured to adjust an output speed of the motor assembly through a pressing stroke of the trigger;
the trigger comprises a base and a limiting portion arranged on the base, the shift assembly comprises a stop portion arranged corresponding to the limiting portion, and the limiting portion is configured to abut against the stop portion.

2. The hand-held power tool according to claim 1, wherein the stop portion is connected to the button, and is configured to move with movement of the button.

3. The hand-held power tool according to claim 2, wherein the stop portion is located between the button and the base, and is at least partially located between the trigger and the switch component.

4. The hand-held power tool according to claim 1, wherein states of the output end comprise a first state and a second state, and speeds in the first state and the second state are different; the transmission assembly comprises a movable inner gear ring, positions of the button comprise a first position corresponding to the first state and a second position corresponding to the second state, the shift component is connected to the inner gear ring; the button is configured to shift between the first state and the second state by moving.

5. The hand-held power tool according to claim 4, wherein an end surface of the base facing the stop portion defines a slideway, the stop portion is configured to move in the slideway, and the limiting portion is located within the slideway to enable the trigger to be only moveable between a part of the pressing stroke, so as to limit a maximum output speed of the motor assembly.

6. The hand-held power tool according to claim 5, wherein the slideway comprises a first slideway corresponding to the first position and a second slideway corresponding to the second position, the limiting portion is arranged on at least one of the first slideway and the second slideway.

7. The hand-held power tool according to claim 6, wherein the first state is a low-speed mode, the second state is a high-speed mode; the stop portion is configured to move in the first slideway when the output end is in the first state, the stop portion is configured to move in the second slideway when the output end is in the second state, and the limiting portion is arranged on the second slideway.

8. The hand-held power tool according to claim 7, wherein the shift assembly comprises an intermediate plate fixed to the housing and a guide member connected between the shift component and the button, the intermediate plate defines a guide groove extending through the intermediate plate, and the guide member is configured to move in the guide groove.

9. The hand-held power tool according to claim 8, wherein the motor assembly comprises a first axis extending in a front-rear direction, the button is configured to move along a second axis perpendicular to the first axis, and the extension direction of the guide groove and the second axis are arranged at an angle.

10. The hand-held power tool according to claim 9, wherein the button comprises a flange extending from an end surface of the button toward the intermediate plate, and the guide member abuts against the flange.

11. The hand-held power tool according to claim 10, wherein the guide member comprises a jaw connected to the shift component and a guide pillar extending downwardly from a bottom of the jaw, and the guide pillar penetrates the guide groove and abuts against the flange.

12. A hand-held power tool, comprising
a housing;
a motor assembly and a transmission assembly, both arranged on the housing;
a switch assembly, connected to the motor assembly, and comprising a switch component arranged on the housing and a trigger configured to trigger the switch component;
a shift assembly, connected to the transmission assembly, and comprising a shift component connected to the transmission assembly, a button configured to move the shift component, and a stop portion connected to the button; and
an output end, configured to be driven by the transmission assembly;
wherein the switch assembly is a speed adjusting switch configured to adjust an output speed of the motor assembly through a pressing stroke of the trigger;
states of the output end comprise a first state and a second state, and speeds in the first state and the second state are different;
positions of the button comprise a first position corresponding to the first state and a second position corresponding to the second state;
the trigger comprises a base, an end surface of the base defines a slideway, the slideway comprises a first slideway corresponding to the first position and a second slideway corresponding to the second position, the stop portion is configured to move with movement of the button and configured to shift between the first state and the second state by moving in the first slideway or in the second slideway.

13. The hand-held power tool according to claim 12, wherein in the first state, the stop portion is configured to move within the first slideway; and in the second state, the stop portion is configured to move within the second slideway.

14. The hand-held power tool according to claim 13, wherein the limiting portion is arranged on at least one of the first slideway and the second slideway, the trigger comprises a limiting portion arranged on the base, and the limiting portion is configured to abut against the stop portion.

15. The hand-held power tool according to claim 14, wherein the first state is a low-speed mode, the second state is a high-speed mode; the stop portion is configured to move in the first slideway when the output end is in the first state, the stop portion is configured to move in the second slideway when the output end is in the second state, and the limiting portion is arranged on the second slideway.

16. A hand-held power tool, comprising
a housing;
a motor assembly and a transmission assembly, both arranged on the housing;
a switch assembly, connected to the motor assembly, and comprising a switch component arranged on the housing and a trigger configured to trigger the switch component;
a shift assembly, connected to the transmission assembly, and comprising a shift component connected to the transmission assembly and a button configured to move the shift component; and
an output end, configured to be driven by the transmission assembly;
states of the output end comprise a first state and a second state, the first state is a low-speed mode state and the second state is a high-speed mode state;
wherein the switch assembly is a speed adjusting switch configured to adjust an output speed of the motor assembly through a pressing stroke of the trigger;
the trigger is only moveable between a part of the pressing stroke in at least one of the first state and the second state, and the pressing stroke of the trigger in the first state is longer than the pressing stroke of the trigger in the second state.

17. The hand-held power tool according to claim 16, wherein the trigger comprises a base and a limiting portion arranged on the base, the shift assembly comprises a stop portion arranged corresponding to the limiting portion, and the limiting portion is configured to abut against the stop portion.

18. The hand-held power tool according to claim 17, wherein an end surface of the base facing the stop portion defines a slideway, the stop portion is configured to move in the slideway, and the limiting portion is located within the slideway to enable the trigger to be only moveable between a part of the pressing stroke, so as to limit a maximum output speed of the motor assembly.

19. The hand-held power tool according to claim 18, wherein the slideway comprises a first slideway corresponding to the first state and a second slideway corresponding to the second state, the limiting portion is arranged on at least one of the first slideway and the second slideway.

20. The hand-held power tool according to claim 19, wherein the speed ratio of the speed in the high-speed mode state to the speed in the low-speed mode state is less than 3.
